(19) United States
(12) Patent Application Publication
(10) Pub. No.: US 2015/0302036 A1
(43) Pub. Date: Oct. 22, 2015

(54) METHOD, SYSTEM AND COMPUTER PROGRAM FOR INFORMATION RETRIEVAL USING CONTENT ALGEBRA

(71) Applicant: INPLORE INC., Boston, MA (US)

(72) Inventors: VIKRAM S. KUMAR, Boston, MA (US); JOHN M. HIGGINS, Cambridge, MA (US)

(21) Appl. No.: 14/689,788

(22) Filed: Apr. 17, 2015

Related U.S. Application Data
(60) Provisional application No. 61/981,304, filed on Apr. 18, 2014.

(51) Int. Cl. G06F 17/30

(52) U.S. Cl. CPC G06F 17/30324; G06F 17/30867; G06F 17/30554; G06F 17/3053

(57) ABSTRACT

The invention comprises systems, methods and computer programs for information retrieval using content algebra. In an embodiment, the invention comprises (i) receiving a first plurality of search results returned by the search engine in response to a first search query, (ii) generating a first plurality of search result vectors, wherein each of the first plurality of search result vectors may be generated based on a corresponding search result from among the first plurality of search results and may comprise data describing the corresponding search result, (iii) generating a first search result image vector based on data from the first plurality of search result vectors, and (iv) displaying information representative of the first plurality of search results on a display device such that visual configuration of the displayed information may be based on data within the first search result image vector.

### CROSS-REFERENCE TO RELATED APPLICATION

This application claims priority to U.S. Provisional Patent Application No. 61/981,304, filed Apr. 18, 2014, the entire contents of which are incorporated by reference herein.

### FIELD OF THE INVENTION

The invention relates to methods, systems and computer programs for information retrieval using content algebra. In particular, the invention enables searching documents or websites, and more particularly to retrieving, representing, integrating, and presenting search results in vector formats that enable efficient viewing, interpretation, synthesis, and storage, and subsequent search operations on stored search results and stored integrated search results.

### BACKGROUND

Documents and websites stored within a network, an internetwork or on standalone computing devices are searchable using search tools and search engines. A variety of search algorithms have been developed to implement and achieve search capabilities within a computing device, as well as across networked devices. However, less attention has been afforded to presentation, storage, integration, and manipulation of search results. Typically, search results are presented to a searching user in the form of document surrogate lists—which comprises displaying search results as a vertical list of information summarizing and linking to the data, information, documents or files returned by the search. For the purposes of this background and also in describing the present invention, the term “search result(s)” shall be understood to include (i) identification of one or more occurrences of search term(s) or search string(s) within a single instance of a data record, document, data file, website or webpage, (ii) identification of one or more instances of data records, documents, data files, websites or webpages that are found to include occurrences of search term(s) or search string(s) and (iii) identification of one or more instances of data records, documents, data files, websites or webpages which do not include exact or literal occurrences of search term(s) or search string(s) but which include terms that are semantically or contextually relevant to or associated with search term(s) or search string(s).

There are certain problems with existing solutions for retrieval and presentation of search results. First, search results displayed by a search engine are displayed in order of pre-defined search algorithms, which search algorithms are defined to effectively cater to a wide population segment. This prevents search results from being tailored for each individual user or more specifically, tailored in response to each individual query.

Document surrogate lists often span multiple pages, requiring a user to visit several pages of search results, or to scroll through a large number of results before finding relevant search results.

Existing search tools also offer only limited capabilities for nested searching, with the large majority relying on complex arrangements of Boolean operators within an earlier executed search string to refine results. Such tools also do not provide solutions for searching in a time-phased manner, wherein a search-in-progress may be stored and iteratively modified, manually, or in a programmatic fashion.

Search results from existing search tools represent a “first-order” analysis of the network resources. Prior art tools do not enable a second-order analysis that would investigate patterns within the search results, or a higher-order analysis that would look for patterns within collections of search results.

Additionally, prior art search tools do not readily enable customization of search queries or refining of search results based on user specific context information.

Further, existing search tools do not offer capabilities for revisiting results of earlier searches to track changes that may have arisen as a consequence of changes to documents available within a computing device or network, or for conveniently sharing results of a search between devices or users.

There is accordingly a need to overcome these multiple deficiencies in the state of art.

### SUMMARY

The invention comprises systems, methods and computer programs for information retrieval using content algebra. The invention enables obtaining, selecting, displaying, storing and enabling subsequent operations on results of search.

In an embodiment, the invention comprises a processor implemented method for information retrieval.

The method comprises (i) receiving a first plurality of search results returned by the search engine in response to a first search query, (ii) generating a first plurality of search result vectors, wherein each of the first plurality of search result vectors may be generated based on a corresponding search result from among the first plurality of search results and may comprise data describing the corresponding search result, (iii) generating a first search result image vector based on data from the first plurality of search result vectors, and (iv) displaying information representative of the first plurality of search results on a display device such that visual configuration of the displayed information may be based on data within the first search result image vector.

In an embodiment of the method each of the first plurality of search result vectors may comprise a plurality of dimensions. Additionally, one or more of said plurality of dimensions may record parameter data descriptive of the corresponding search result.

At least one of the first plurality of search result vectors may comprise first, second and third dimensions. The first dimension may record identifier data related to the corresponding search result. The second dimension may record location of data that caused the search engine to return the corresponding search result. The third dimension may record any one or more of (i) a data summary of, or data extract from, the corresponding search result, (ii) one or more of strings, topics, concepts, sentiments or frequency of occurrence of specific data, within the corresponding search result, or (iii) a score indicating relevance of the corresponding search result.

In an embodiment of the method, the first search result image vector may comprise a fourth, fifth and sixth dimensions. The fourth dimension may record data corresponding to the first search query. The fifth dimension may record data identifying search results intended for display on the display device. The sixth dimension may record any one or more of (i) data corresponding to a search algorithm used by the search engine, (ii) one or more visual or textual identifiers used for display of a search result on the display device, (iii) one or more display attributes of visual or textual identifiers, (iv) relevance scores extracted from third dimensions corresponding to one or more of the first plurality of search result vectors (v) information enabling access to one or more of the first plurality of search result vectors (vi) information describing data recorded within dimensions of one or more of the first plurality of search result vectors, or (vii) predefined scoring criteria for comparing relevance scores of two or more of the first plurality of search result vectors.

In a further method embodiment, the visual configuration of the displayed information may be based on a comparison of relevance scores extracted from two or more of the first plurality of search result vectors.

The method may additionally comprise generating a second search query, wherein the second search query differs from the first search query in at least one search parameter or in at least one data source on which the second search query is intended to be executed. The second search query may be transmitted to the search engine.

The method may include receiving a second plurality of search results returned by the search engine in response to the second search query. A second plurality of search result vectors may be generated, wherein each of the second plurality of search result vectors is generated based on a corresponding search result from among the second plurality of search results and comprises data describing the corresponding search result. A second search result image vector may subsequently be generated based on data extracted from the second plurality of search result vectors, and information representative of the second plurality of search results may be displayed on a display device, such that a visual configuration of the displayed information is based on data extracted from the second search result image vector.

The method may further comprise implementing one or more data set operations based on a first data set comprising data from the first search result image vector and a second data set comprising data from the second search result image vector. A third search result image vector may be generated based on a third data set resulting from the one or more data set operations. The result of the one or more data set operations may be displayed on a display device, such that visual configuration of the displayed result is based on data extracted from the third search result image vector. At least one of the implemented one or more data operations may comprise a union operation, a difference operation or an intersection operation.

In a method embodiment, the second search query may comprise one or more contextual search parameters based on contextual data associated with a querying user.

The invention may additionally comprise a system configured for information retrieval. The system may include a processor, a search result vector generator, a search result image vector generator and a display controller.

The search result vector generator may be configured to receive a plurality of search results returned by a search engine in response to a first search query, and to generate a first plurality of search result vectors. Each of the first plurality of search result vectors may be generated based on a corresponding search result from among the first plurality of search results and may comprise data describing the corresponding search result.

The search image vector generator may be configured to generate a first search result image vector based on data from the first plurality of search result vectors.

The display controller may be configured to display information representative of the first plurality of search results on a display device, wherein visual configuration of the displayed information is based on data within the first search result image vector.

At least one of the first plurality of search result vectors may comprise first, second and third dimensions. The first dimension may record identifier data related to the corresponding search result. The second dimension may record location of data that caused the search engine to return the corresponding search result. The third dimension may record any one or more of (i) a data summary of or data extract from the corresponding search result, (ii) one or more of strings, topics, concepts, sentiments or frequency of occurrence of specific data, within the corresponding search result, or (iii) a score indicating relevance of the corresponding search result.

The first search result image vector may comprise fourth, fifth and sixth dimensions. The fourth dimension in the first search image vector may record data corresponding to the first search query. The fifth dimension in the first search image vector may record data identifying search results intended for display on the display device. The sixth dimension in the first search image vector may record any one or more of (i) data corresponding to a search algorithm used by the search engine, (ii) one or more visual or textual identifiers used for display of a search result on the display device, (iii) one or more display attributes of visual or textual identifiers, (iv) relevance scores extracted from third dimensions corresponding to one or more of the first plurality of search result vectors, (v) information enabling access to one or more of the first plurality of search result vectors, (vi) information describing data recorded within dimensions of one or more of the first plurality of search result vectors, or (vii) predefined scoring criteria for comparing relevance scores of two or more of the first plurality of search result vectors.

The search result generator of the system may be configured to generate a second search query, wherein the second search query differs from the first search query in at least one search parameter or in at least one data source on which the second search query is intended to be executed. The processor may be configured to transmit the second search query to the search engine.

The search result vector generator of the system may further be configured to respond to receipt of a second plurality of search results returned by the search engine in response to the second search query, by generating a second plurality of search result vectors. Each of the second plurality of search result vectors may be generated based on a corresponding search result from among the second plurality of search results and may comprise data describing the corresponding search result.

The search result image vector generator may additionally be configured to generate a second search result image vector based on data extracted from the second plurality of search result vectors.

The display controller of the system may be configured to display information representative of the second plurality of search results on a display device, wherein visual configuration of the displayed information is based on data extracted from the second search result image vector.

The system may additionally comprise an image vector comparator configured to implement one or more data set operations based on a first data set comprising data from the first search result image vector and a second data set comprising data from the second search result image vector. The implemented one or more data operations of the system may comprise any of a union operation, a difference operation or an intersection operation.

In an embodiment of the system, the search result image vector generator may be configured to generate a third search result image vector based on a third data set resulting from the one or more data set operations.

In another system embodiment, the display controller may be configured to display a result of the one or more data set operations on a display device, wherein visual configuration of the displayed result is based on data extracted from the third search result image vector.

The invention may additionally include a computer program product for information retrieval, which computer program product comprises computer readable instructions for implementing method embodiments of the present invention.

### BRIEF DESCRIPTION OF THE ACCOMPANYING DRAWINGS

FIGS. 1, 2 and 3 to 8 illustrate method embodiments of the present invention.

FIG. 2A illustrates an exemplary search result image generated by the invention.

FIGS. 9 and 10 illustrate system embodiments of the present invention.

### DETAILED DESCRIPTION

The invention is directed to systems, methods and computer programs for selecting, displaying, storing and enabling subsequent operations on results returned by a search, whether on stand alone computing devices or on networked devices. For the purposes of the invention, it would be understood that search results may comprise links to (or locations or extracts of) data, information, documents, webpages or websites that include the search terms (or related concepts) identified in a search query. Alternatively search results may include links to (or location(s) or extracts of) one or more search terms found within a specific item of data or information, document, webpage or website.

The invention retrieves search results and stores each search result as a search result vector having a plurality of dimensions. A dimension of a search result vector may record one or more parameters relevant to identifying or describing the corresponding search result, or which enables assessment of relevance of the corresponding search result. By way of example, dimensions of a search result vector may record one or more of (i) a search result identifier, (ii) a link to (or location of) data, information, file, document, webpage or website (or relevant portion(s) thereof) which caused a search result to be returned, (iii) a summary or extract corresponding to the search result, (iv) strings, topics, concepts, sentiments, and/or the frequency of their occurrences in the search result, or (v) a weight or score indicating relevance of the corresponding search result.

The invention may thereafter generate a search result image vector, which search result image vector defines a visual configuration for display of the search results (i.e. a search result image). A search result image vector may include a plurality of dimensions, each of which records a parameter for display of the search results. A dimension of a search result image vector may record one or more of (i) a search query used to generate the search result image, (ii) search algorithms used for the search, (iii) search result(s) represented within the search result image, (iv) visual or textual identifiers used to represent each search result within the search result image, (v) display attributes of the visual or textual identifiers or of the represented search results within the search result image,(vi) relevance scores corresponding to search result vectors within the search result image, (vii) information enabling access to search result vectors corresponding to each search result included within the search result image,(vii) descriptive information on the content of dimensions of a search result vector (such as whether a string represents a person or a location or the search query term itself), and (viii) pre-defined scoring criteria that may have been used for comparing relevance scores of search result vectors within the search result image.

Since a search result image comprises a display configuration for search results returned by a search, the search result image vector may include information retrieved from one or more dimensions of search result vectors corresponding to the displayed search results. In a particular embodiment, a search result image vector may comprise the entire set of search result image vectors corresponding to search results intended for display. In an embodiment, a search result image vector may be generated by combining search result image vectors corresponding to search results intended for display—which combination may be arrived at by a linear combination, or any other combination methods known in the art.

Consequently, display attributes of a search result within a search result image may be based on an assessment of one or more dimensions of the search result vector. In an embodiment of the invention, display attributes (such as representation and location) of each search result vector within the search result image may be based on a comparison of a relevance score for each search result vector. The relevance score for a search result vector may be determined by evaluating one or more vector dimensions of the search result vector, based on one or more pre-defined scoring criteria. Display of a search result vector within a search result image may therefore change in response to one or more of, modification of one or more dimensions of the search result vector, modification of a relevance score corresponding to the search result vector, and/or modification of a pre-defined scoring criteria for generating relevance scores. By appropriately positioning and sizing search result vectors within the search result image, the invention may be configured to provide a user with a consolidated single image capable of simultaneously displaying all search results returned in response to a search query. Simultaneously, by enabling a combination of data from individual search result vectors into a single search result image vector, the invention enables recording of results returned by a search within a discrete data structure, which data structure may be saved, and thereafter retrieved, shared, and manipulated in accordance with any of the embodiments discussed below.

A representation of a search result within a search result image may include a link to the data, information, document, webpage, or website corresponding to the vectorized search result. The link may be accessed using routine software applications such as browser applications, wherein clicking or selecting the representation of the search result vector displayed within the search result image causes the corresponding linked data, information, document, webpage or website to be displayed. In an embodiment of the invention, selection of a search result displayed within a search result image may cause an extract or a summary of the data, information, documents, webpages or websites corresponding to such search result to be added to a document or file, which document or file may be stored and/or communicated. In an embodiment, this may be achieved by accessing the selected search result based on link or location information obtained from the corresponding search result vector, and obtaining an extract or generating a summary thereof. By selecting multiple search results within an image, a user may add extracts or summaries corresponding to each search result to such document or file—thereby creating a document or file summarizing information that the user may have found relevant among search results displayed within the search result image.

Search results returned by an executed search query may accordingly be saved and shared between users or computing devices, by sharing (i) the generated search result image, (ii) a search result image vector corresponding to the search result image, or (iii) a document or file including extracts or summaries corresponding to search results within the search result image, that have been selected by a user.

It would be understood that a search result image may be generated subsequent to and based upon a generated search result image vector. Conversely in a specific embodiment, a search result image vector may be generated subsequent to and based upon a search result image displayed at a user interface.

Search result image vectors may be stored in a database, repository or other volatile or non-volatile storage, each stored search result image vector thereby creating an accessible record of search results returned in response to a particular search query.

Storage of a search result image vector enables a search query corresponding to the generated search result image vector to be extracted and thereafter modified for execution of a new search based on the modified search query. Modification of a search query may include execution of nested searches to refine search results returned in response to execution of the original search query. Search results returned based on a modified search query may be displayed as a new search result image. A stored search result image vector equally enables a second execution of the original search query associated with the search result image vector, to ascertain or track any changes in search results that may have arisen as a consequence of changes to documents or data available within the computing device or network. Yet further, by extracting from a search result image vector and thereafter modifying one or more of (i) search algorithms used, (ii) vector dimensions used to evaluate relevance scores of the vector image, and (iii) pre-defined scoring criteria for comparing relevance scores of search result vectors—a user may execute a fresh search using the original search query associated with the search result image vector, with a view to generate a modified set of search results, which modified search results may be displayed as a new search result image.

In a particular embodiment, a user may identify specific information, data, files, websites or webpages (for example, by way of a data push or transmission of the information, data, files, websites or webpages, or by identifying links thereto or locations thereof) on which a search query extracted from a previously generated search result image vector is required to be executed. The results of the new search may thereafter be used to modify the search results of the original search result image vector and/or search result image. By way of illustration, assuming a user has generated a search result image vector corresponding to a search query for “coffee shops”, such user may subsequently “push” a link to online yellow pages to the previously generated search result image vector—causing the search query extracted from the original search result image vector to be re-run, including over the pushed online yellow pages, and resulting in generation of a new search result image vector which would include results corresponding to coffee shops found within the online yellow pages.

Generation and storage of a search result image vector corresponding to results returned by an executed search query additionally enables a user to generate narrower and more directed search results by implementing appropriate data set operations on (i) a first data set comprising search results within a first search result image vector and (ii) a second data set comprising search results within a second search result image vector. Search results returned in response to the implemented data set of operations may be displayed within a new search result image, and may be stored as a corresponding new search result image vector.

An illustrative example of a data set operation that may be implemented on a first data set comprising a first search result image vector and a second data set comprising a second search result image vector, comprises application of the union operator to said first and second data sets—which would result in a third data set comprising a union of the first and second data sets. The search results within this third data set may be displayed as a third search result image, and may be stored as a corresponding third search result image vector.

Similarly, an intersection operation or a difference operation may be implemented on a first data set comprising a first search result image vector and a second data set comprising a second search result image vector—and would result in a third data set comprising the intersection or difference respectively of the first and second data sets. The third data set comprising results of the intersection operation or the difference operation may be displayed as a third search result image, and may be stored as a corresponding third search result image vector.

In an embodiment of the invention, display attributes of search results within the third search result image (and corresponding to the third search result image vector) may be selected to convey meaningful information regarding the results themselves. For example, in a difference operation applied to a first search result image and a second search result image, the resulting third search result image may use black text characters to depict search results present more strongly in the first search result image than in the second search result image, and may use red text characters to depict search results present more strongly in the second search result image than in the first search result image. Other non-limiting examples of display attributes that may be used to convey information may include size, position within an image, shape and font attributes (e.g. underline, strikethrough etc.).

It would be understood that the above examples of union, intersection or difference operations are only illustrative, and that search result image vectors may be subjected to any other selected data set operations (or combinations thereof) such that the results returned by such data set operations may be displayed as a new search result image, and may be stored as a new search result image vector.

The invention additionally enables contextual refining of search results. This is achieved by collecting data from personal data sources corresponding to or associated with a user, and representing collected contextual data within at least one contextual data vector having one or more dimensions. A contextual data vector dimension may comprise one or more parameters relevant to identifying or describing the corresponding item of contextual data. In executing a search query within a collection of data, information, documents, webpages or websites, the invention may add one or more parameters extracted from a contextual data vector to a search query or search string, to restrict or refine results to search results that are contextually relevant to the user. In another embodiment, a user may refine search results within a search result image vector by ascertaining an intersection between (i) a first data set comprising search results within the search result image vector, and (ii) a second data set comprising returned search results based on execution of search terms extracted from a contextual data vector.

A user may also modify one or more parameters of a search result image vector (such as for example, a search query used to generate the vector image, display attributes of search result vectors within the vector image, relevance scores corresponding to search result vectors within the vector image, vector dimensions used to evaluate relevance scores of the vector image or pre-defined scoring criteria for comparing relevance scores of search result vectors) based on contextual data extracted from a contextual data vector corresponding to the user.

The contextualized search results generated in accordance with any of the above may be displayed as a new search result image.

In another embodiment of the invention, a user may identify specific information, data, files, websites or webpages (for example, by way of a data push or transmission of the information, data, files, websites or webpages, or by identifying links thereto or locations thereof) for storage within a searchable data source. By doing so, a user adds the selected information, data, files, websites or webpages to the searchable data sources—so that future search queries can be executed on such data or information.

In an alternative embodiment, a user may identify specific information, data, files, documents, websites or webpages for generation of vectors and display images based thereon. The step of identification may be implemented in any one of several ways, including for example by way of a data push or transmission of the information, data files, websites or webpages, or by identifying links thereto or locations thereof. Responsive to accessing the identified data, information, data file, document, website or webpage, a summary vector having a plurality of dimensions is generated. A dimension of the summary vector may record one or more parameters relevant to identifying or describing the corresponding item data, information, file, document, website or webpage, or which enables assessment of contents thereof. By way of example, dimensions of a summary vector may record one or more of (i) an identifier, (ii) a link to (or location of) data, information, file, document, webpage or website (or relevant portion(s) thereof) which caused the summary vector to be generated, (iii) a summary or extract of content from item of data or information or (iv) strings, topics, concepts, sentiments, and/or the frequency of their occurrences within the item of data or information. The summary vector may be stored in a database—which in an embodiment may be the same repository or database used to store search result image vectors.

The invention may thereafter generate a summary image based on information within the summary vector. The generated summary image may visually present one or more of (i) a summary or extract of content from the data, information, file, document, website or webpage corresponding to the summary vector and (ii) strings, topics, concepts, sentiments, and/or the frequency of their occurrences within said data, information, file, document, website or webpage corresponding to the summary vector. Content for visual presentation within the summary image may be extracted from one or more dimensions of the corresponding summary vector. Additionally display attributes selected for specific items of content within the summary vector may depend on the relative prominence or weight accorded to said items of content within the originating data, information, file, document, website or webpage that was used to generate the summary vector and summary image.

It would be understood that summary images and summary image vectors may be combined with search result images and search result vectors in any of the ways discussed previously or hereinbelow, and may be used for implementation of data set operations in the same manner as has been discussed previously in connection with search result images and search result image vectors.

For the purposes of this invention, in generating one or more of summaries or extracts of content from an item or information or data, file, document, website or webpage, any one or more known methods and systems may be used to parse data and generate the desired summary or extract. In a specific implementation of this invention, generating a summary or extract may comprise the steps of (i) parsing an item of data or information into a collection of discrete words, (ii) creating groups of successive discrete words, wherein each succeeding word is included in the same group as the preceding word unless the succeeding word is a pre-defined stop word, in which case no more words are added to the present group and a new group is started with the first non-stop word that occurs thereafter, (iii) treating each group which includes a pre-defined number or range of numbers of discrete successive words, as a phrase for inclusion within the extract or summary of content.

In the above embodiment, the invention may provide a pre-defined list of stop words which are treated as delimiters for creation of new word groups. Non-limiting and illustrative examples of pre-defined limiters may include the words “a”, “and”, “the”, “are”, “his” and “her”. In an embodiment of the invention, any group of words comprising at least two successive words that are not separated by a stop word may be included within the extract or summary.

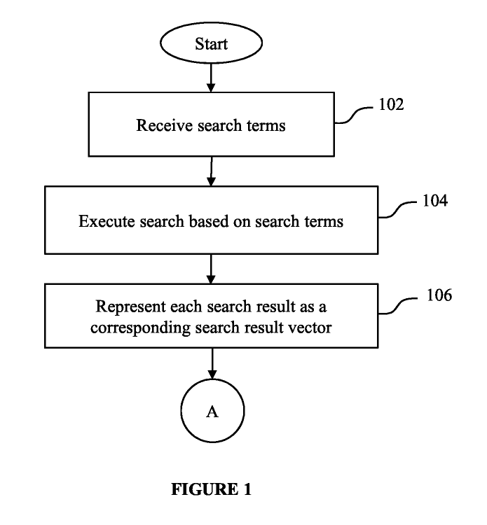

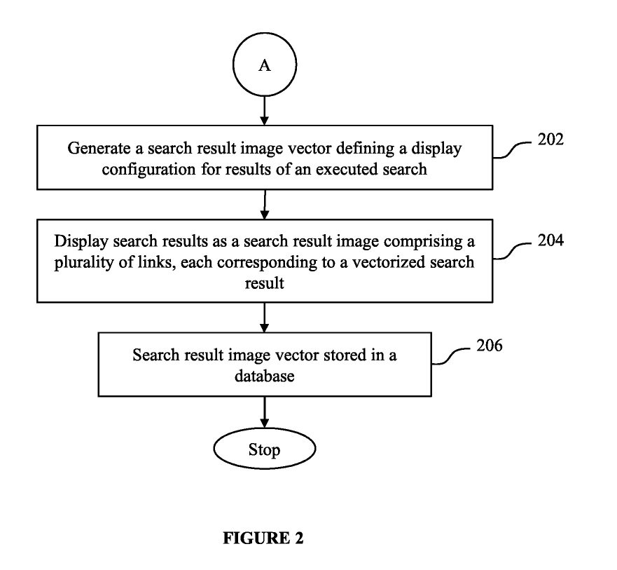

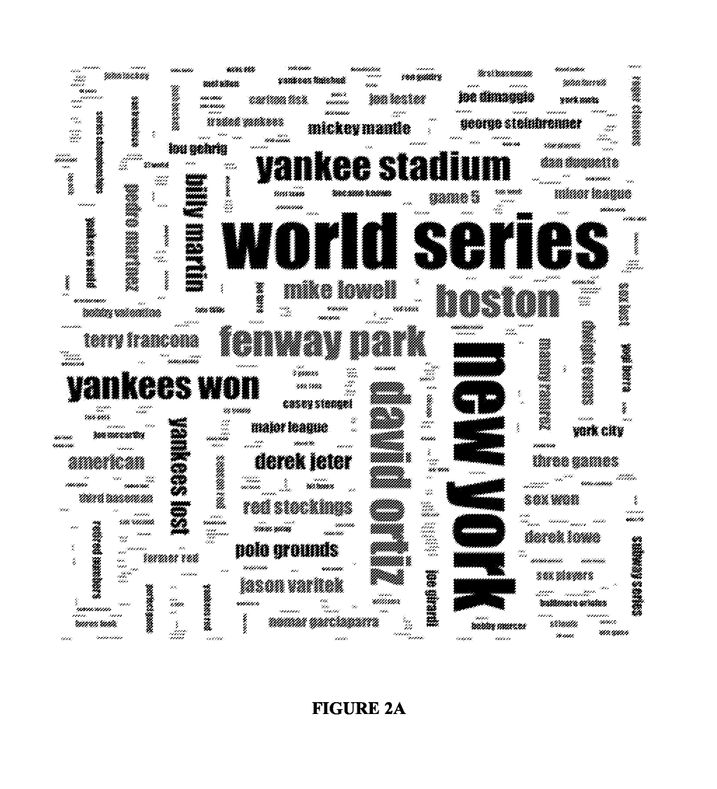

FIGS. 1 and 2 illustrate method embodiments of the present invention. At step 102, a search query comprising one or more search terms is received. The search query may be received at a search engine comprising one or more processors configured to search through one or more searchable data sources. The one or more searchable data sources may comprise any one or more of data, data files, documents, webpages, websites or other representations of information stored in one or more data repositories or databases. The search query may be generated by way of user input through a user interface, or alternatively may be generated based on search terms or search strings communicated from a computing device or retrieved from a repository.

At step 104, the search engine executes the search query based on search terms or search string(s) therewithin, by searching for matches or hits within the one or more searchable data sources.

At step 106, each search result returned by the search engine is represented as a search result vector having a plurality of dimensions. In an embodiment of the invention, at least one dimension of a search result vector may comprise one or parameters or items of information which record one or more of (i) a search result identifier, (ii) a link to (or location of) data, information, file, document, webpage or website (or relevant portion(s) thereof) which caused a search result to be returned, (iii) a summary or extract corresponding to the search result, (iv) strings, topics, concepts, sentiments, and/or the frequency of their occurrences in the search result, or (v) a weight or score indicating relevance of the corresponding search result.

In a more particular embodiment, at least one dimension of the search result vector comprises a descriptor of or link to the corresponding search result or relevant part thereof, and at least a second dimension of the search result vector comprises information describing or reproducing at least a part of the relevant content of the corresponding search result, or indicating absolute or relative relevance of the search result. In another embodiment, one dimension of the search result vector may comprise a string, while another dimension may comprise information representing frequency of occurrence of the string in the search result. Relevance scores for a search vector may be determined by evaluation of one or more vector dimensions of each search result vector, based on one or more pre-defined scoring criteria.

It would be understood that search result vector may be implemented by way of any data structure capable of storing data or information corresponding to each dimension of the search result vector. Illustrative examples of appropriate data structures include tables, arrays, matrices, and records.

Thereafter at step 202 of FIG. 2, a search result image vector is generated, which search result image vector comprises information defining a display configuration for results of the search executed in the previous search steps (i.e. described in connection with FIG. 1). A search result image vector may comprise a plurality of dimensions, one or more of which may describe the selection of search results to be displayed, and display attributes of each search result. In an embodiment of the invention, dimensions corresponding to a description of search results to be displayed within the search result image may include identifiers of or links to search result vectors corresponding to each search result that is to be displayed. The dimensions describing display attributes of each search result may include one or more of (ii) descriptor or content corresponding to the search result that is intended to be displayed (i) display location, (ii) size, (iii) shape, (iv) color, and (v) any other display attributes specific to rendering the search result on a display.

Dimensions describing display attributes of each search result (including one or more of display location, size, shape, font attributes, and color) may be selected based on a determined relevance of the specific search result—which relevance may be assessed based on comparison of one or more dimensions of each search result vector, or based on properties of the search results themselves. In a specific embodiment, display attributes of each search result within the search result image are selected such that search results that are determined to be of higher relevance are displayed more prominently than search results that are determined to be of lower relevance.

Dimensions of a search result image vector may additionally include information corresponding to one or more of (i) a search query used to generate the vector image, (ii) search algorithms used for the search, (iii) relevance scores corresponding to search result vectors within the vector image (vi) vector dimensions used to evaluate relevance scores of the vector image and (vii) pre-defined scoring criteria for comparing relevance scores of search result vectors.

Search result image vectors may be implemented by way of any data structure capable of storing data or information corresponding to each dimension of the search result vector. Illustrative examples of appropriate data structures include tables, matrices, and records.

At step 204, a search result image is displayed based on or corresponding to the generated search result image vector. The displayed search result image comprises representations of a plurality of search results, wherein content and attributes of a displayed representation of a search result are based on dimensions of the search result image vector which correspond to such search result. Additionally, each displayed search result may comprise a link to the respective data or information item, document, webpage or website based on which said search result was originally generated. By selecting or clicking on a link corresponding to a search result, a user may be directed to the actual search result or presented the relevant part thereof.

It would be understood that steps 202 and 204 are chronologically interchangeable, or alternatively may be executed simultaneously.

While not specifically illustrated in FIG. 2, in an embodiment of the invention, selection of (such as by clicking on) a search result displayed within a search result image may cause an extract or a summary of the data, information, documents, webpages or websites corresponding to such search result to be added to a document or file, which document or file may be stored and/or communicated. In an embodiment, this may be achieved by accessing the selected search result based on link or location information obtained from the corresponding search result vector, and obtaining an extract or generating a summary thereof. By selecting multiple search results within an image, a user may add extracts or summaries corresponding to each search result to such document or file—thereby creating a document or file (i.e. a summary document) summarizing information that the user may have found relevant among search results displayed within the search result image. In a more particular embodiment, selection of a search result may also add to said summary document, a link to (or location of) data, information, file, document, webpage or website corresponding to said search result.

At step 206, the generated search result image vector may be stored in a database, repository or other volatile or non-volatile storage provided for search result image vectors.

The method of generating a search result image vector and displaying a search result image corresponding to information within the search result image vector enables a flexible approach to displaying search results—and departs from the prior art approach of a vertical linear list of document surrogates. It is known that the human brain understands and learns in a non-linear manner, and is capable of scanning images and picking out surprising or unusual elements, including through peripheral vision. The invention accordingly permits for configurable or customizable display configurations for optimally presenting search results, including display configurations that are non-linear.

An example of a non-linear display configuration is provided in FIG. 2A, which illustrates presentation of search results which includes the search term “Boston Red Sox” and/or “New York Yankees”. The display configuration is presented in the form of a word-cloud (also known as a tag cloud) where each search result is represented by a brief descriptor and provides a link to the corresponding document or data source which generated the search result. The position, size and other display attributes of each search result are determined based on a determined relevance of each search result. In an embodiment of the invention, the relevance of each search result may be represented by a weight or score associated with such search result. It would be understood that the word cloud representation in FIG. 2A is only illustrative and that the display configuration may take any other form including any graph, chart or graphic vector representation which is found to convey information efficiently or meaningfully.

Generation of search result image vectors enables non-transitory storage of search queries and corresponding results returned by such search queries. Such generation and storage inter alia enables (i) modification of earlier search queries for execution of new searches, (ii) execution of nested searches for refining search results, (iii) a further execution of a previously executed search query to ascertain or to track any changes in search results that may have arisen as a consequence of changes to documents, data or information within the searchable data sources and (iv) modification of one or more of previously used search algorithms, vector dimensions used to evaluate relevance scores of the vector image and pre-defined scoring criteria for comparing relevance scores of search result vectors—any and all of which would result in generation of a modified set of search results.

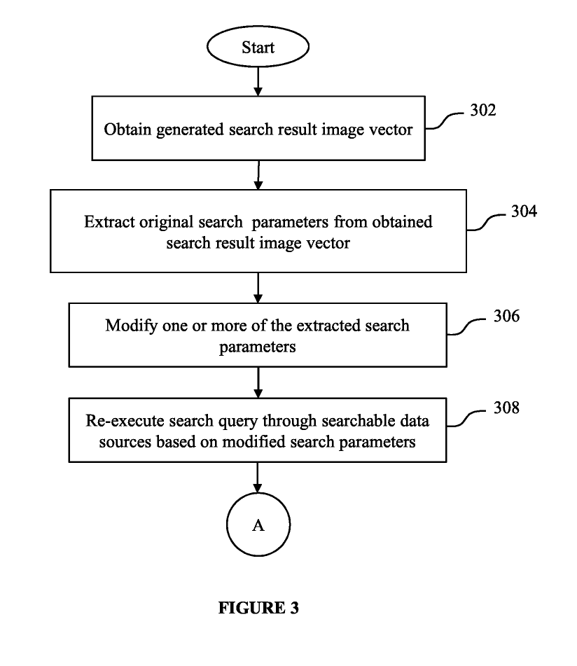

FIG. 3 illustrates a method embodiment of the invention wherein a search result image vector is retrieved and modified for re-execution of the search. At step 302, a search result image vector is obtained. The search result image vector may be generated or may be retrieved from a database or repository of search result image vectors. Thereafter, at step 304 one or more of the original search parameters based on which the search result image vector was originally generated, are extracted. At step 306, one or more of the extracted search parameters may be modified, whereafter step 308 re-executes the search query through the searchable data sources, based on the one or more modified search parameters. Subsequent to step 308, the method may revert to steps 202 to 206 of FIG. 2, such that the results of the modified search query are displayed as a new search result image and/or stored as a new search result image vector.

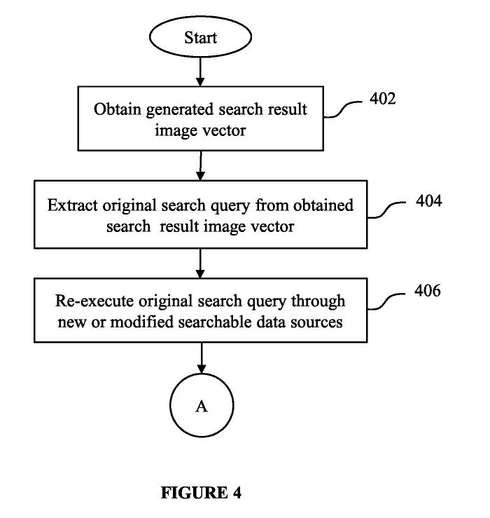

FIG. 4 illustrates another method embodiment of the invention wherein a search result image vector is retrieved and re-executed for search through new or modified searchable data sources. At step 402, a search result image vector is obtained by generation or retrieval. Thereafter, at step 404 the original search parameters based on which the search result image vector was generated, are extracted. At step 406, the extracted original search query is re-executed through new or modified searchable data sources. Subsequent to step 406, the method may revert to steps 202 to 206 of FIG. 2, such that the results of the re-executed search are displayed as a new search result image and/or stored within a new search result image vector. In an embodiment of the invention, display attributes of the new search result image vector may be selected or configured such that the corresponding new search result image specifically highlights or identifies differences between the new search result image and the original search result image.

Re-execution of a previously executed search query through new or modified searchable data sources provides multiple advantages. Such re-execution enables a user to improve earlier search results as additional data sources or search databases become available, without having to recall and re-create the entire set of search terms and/or search parameters from memory. The method additionally allows a user to ascertain or track evolution of search results corresponding to changes occurring to data/information within a searchable data sources over time. For example, it is well understood that data and information resources available on the internet are likely to evolve over time—by way of addition, deletion or modification of available data, information, documents, webpages, websites and files. Extracting search parameters from a previously generated search result image vector and re-executing the original search query over the internet would enable generation of a new search result image which accounts for the data and information changes that may have occurred in the time period between the original search and the re-executed search.

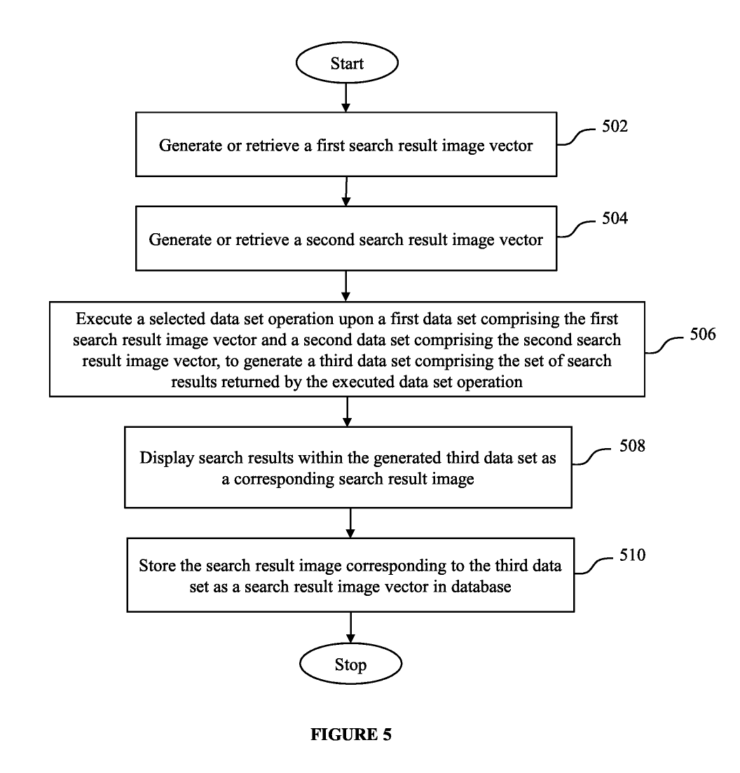

In an embodiment of the invention described in connection with FIG. 5, one or more data set operations may be executed upon a first data set comprising a first search result image vector and a second data set comprising a second search result image vector. The results of the one or more data set operations may be displayed as within a new search result image, and stored as a new search result image vector. Based on selection of the one or more data set operations, a user may accordingly narrow, further direct, or otherwise improve search results.

At steps 502 and 504 of FIG. 5, first and second search result image vectors are either generated or are retrieved from a database. At step 506 at least one selected data set operation is executed upon a first data set comprising the first search result image vector and a second data set comprising the second search result image vector—wherein the at least one selected data set operation returns a third data set of search results comprising a sub-set of the search results originally identified by the first or second search result image vectors. The search results contained within the third data set may be represented by corresponding search result vectors and thereafter may be used to generate a search result image and a search result image vector corresponding to the returned third data set. This generated search result image may be displayed at step 508 and the corresponding search result image vector may be stored in a database at step 510.

The at least one data set operation may comprise any one or more data set operations, and may include one or more of union, intersection or difference operations.

In an embodiment of the invention, execution of a data set operation as described in connection with FIG. 5 may be initiated by (i) selecting a data set operation and dragging and dropping one of a first and second search result images (corresponding respectively to the first and second search result image vectors) onto the other of said first and second search result images, (ii) dragging and dropping the first and second search result images (corresponding respectively to the first and second search result image vectors) into a designated area in some specific order, and choosing the operation to be performed (e.g., intersection, difference), or (iii) selecting a data set operation and selecting a first and second search result images (corresponding respectively to the first and second search result image vectors).

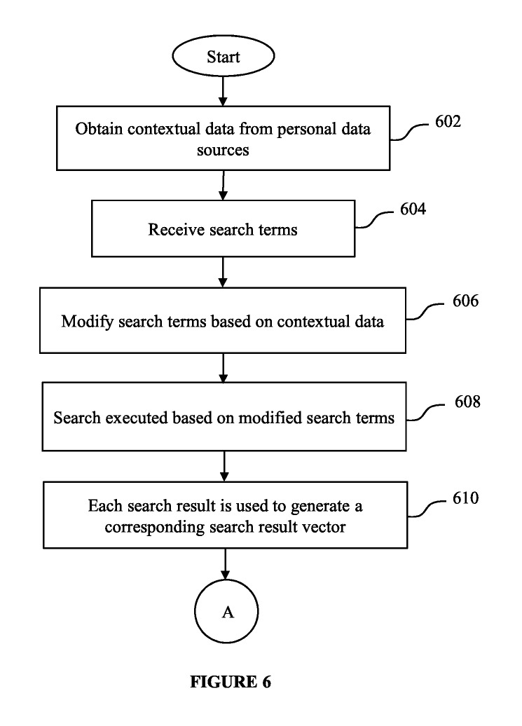

FIG. 6 illustrates a method embodiment of the invention which enables contextual refining of search results. At step 602, contextual data is obtained from personal data sources of a user. Personal data sources of a user may include one or more data sources that may or may not be accessible to a search engine, but which include data, information, documents and/or data files that are related to, associated with, or are of interest to the user. Illustrative examples of personal data sources may include users' private or access restricted data files, users' mailboxes and archived email records, users' LinkedIn, Facebook, Twitter or other social or work related networking accounts, websites and blogs visited or subscribed to by users, and any other restricted or unrestricted electronic, internet or telecommunication service related accounts. Such personal data sources typically include contextual information related to a user—which may be understood as information that describes, illustrates or otherwise indicates users' information interests. Contextual information extracted from personal data sources, when combined with the search methodologies already discussed, provides context to searches executed by a specific user and may be used to target or refine search results and also to optimize a display configuration of search results, based on a determined relevance of search results for the searching user.

By way of example, assuming a user is searching for information on aircraft, data mining one or more personal data sources corresponding to such user (such as his Facebook account and his email accounts) may establish that he is a model aircraft hobbyist. This contextual information may be used to accordingly weight and highlight search results that relate to local model aircraft clubs or necessary municipal permissions for flying model aircraft, such that search results relating to these two topics are displayed more prominently within the search result image.

At step 604, search terms or a search string is received. The search terms or search string may be received from a user or may be extracted from an existing search result image vector. The received search terms or search string(s) may be modified at step 606 by including, removing or altering one or more search terms, wherein a decision regarding such inclusion, removal or alteration is based on an evaluation of the contextual data obtained at step 602. At step 608 the modified search terms or search string is used to execute a fresh search through searchable data sources. Each search result returned by the fresh search may be used to generate a corresponding search result vector. Thereafter, the method may revert to steps 202 to 206 of FIG. 2, such that the results of the fresh search are displayed as a new search result image and/or stored within a new search result image vector.

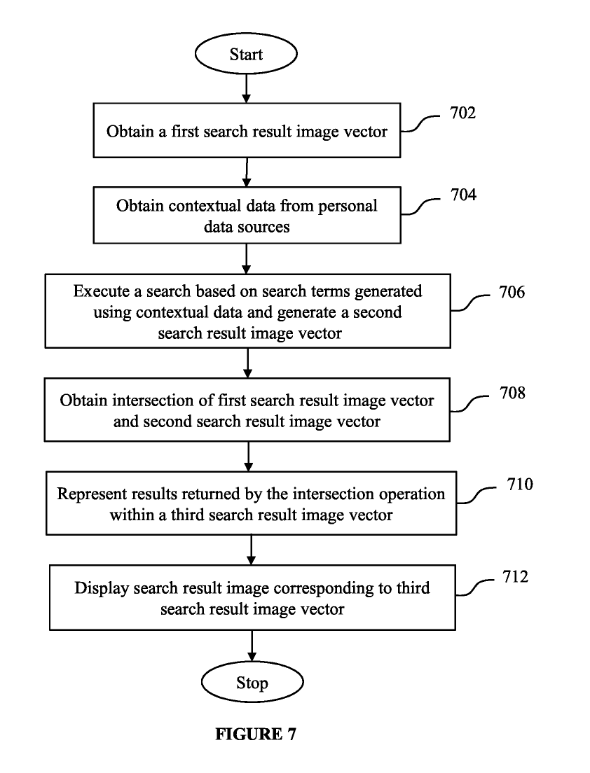

In another method embodiment illustrated in FIG. 7, a user may refine search results represented within a search result image vector by determining an intersection between (i) a first data set comprising search results represented within a search result image vector, and (ii) a second data set comprising search results generated based on search terms extracted from a contextual data vector.

Step 702 of the method embodiment comprises obtaining a first search result image vector. The first search result image vector may be generated in accordance with the methods more fully discussed in connection with FIGS. 1 and 2. Alternatively, the first search result image vector may be retrieved from a database of search result image vectors.

At step 704 contextual data may be obtained from personal data sources relevant to or associated with a searching user. Step 706 comprises execution of a search through searchable data sources including further personal data sources, based on search terms or search string(s) generated using the obtained contextual data. The results returned by this search are represented within a second search result image vector. At step 708, an intersection between the first search result image vector and second search result image vector is obtained. The search results returned by the intersection operation may be represented as a third search result image vector at step 710, and may be displayed as a corresponding search result image at step 712.

The invention also enables modification of one or more parameters of a search result image vector based on contextual data corresponding to the user. Examples of modifiable parameters include the search query used to generate the vector image, display attributes of search result vectors within the vector image, relevance scores corresponding to search result vectors within the vector image, vector dimensions used to evaluate relevance scores of the vector image or pre-defined scoring criteria for comparing relevance scores of search result vectors.

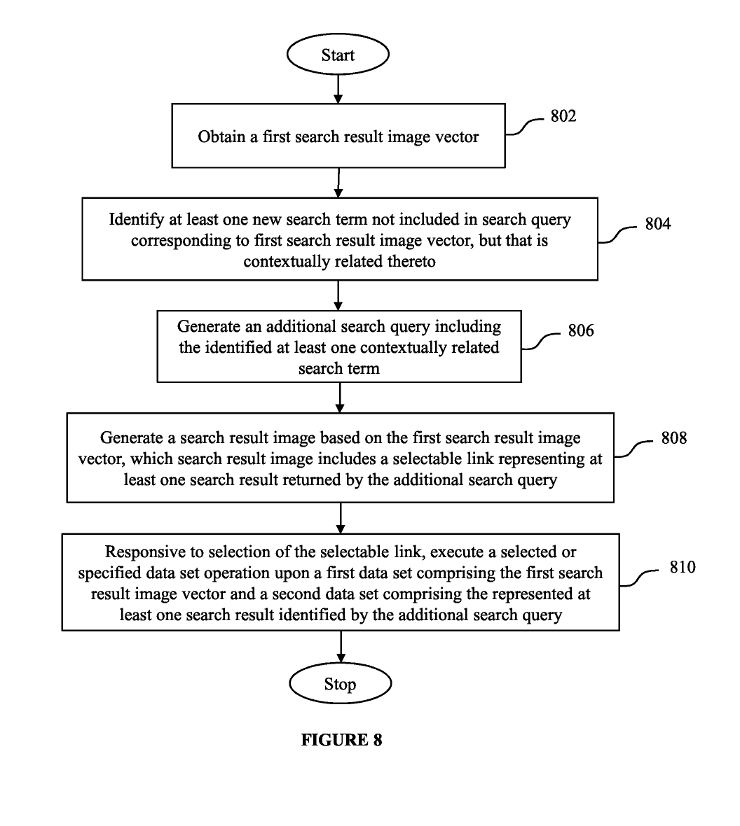

FIG. 8 illustrates another embodiment of the invention. At step 802, a first search result image vector is either generated or retrieved from a database.

At step 804, the method identifies at least one new search term that is not included in the search query corresponding to the first search result image vector, but that is contextually related to said search query. For example, the search query may have included the term “baseball”, and contextually related terms may have been found to include “bat”, “glove”, “pitcher”, “ outfield”, “diamond”, “curve ball”, “short stop” etc. Methods for identification of contextually related terms are known in the art and any one or more such methods may be implemented.

At step 806 an additional search query is generated, based on the identified contextually related search term(s). In one embodiment, the additional search query may consist solely of one or more of the identified contextually related search terms, which are not also included in the search query corresponding to the first search result image vector.

At step 808, a search result image is generated based on the first search result image vector, which search result image may include a selectable link representing at least one search result returned by the additional search query. Responsive to selection of the selectable link at step 810, selected or predefined one or more data set operations are executed upon a first data set comprising the first search result image vector and a second data set comprising the at least one search result represented by the selectable link. The results returned by said data set operations may be used to generate a second search result image for display, and/or a corresponding second search result image vector.

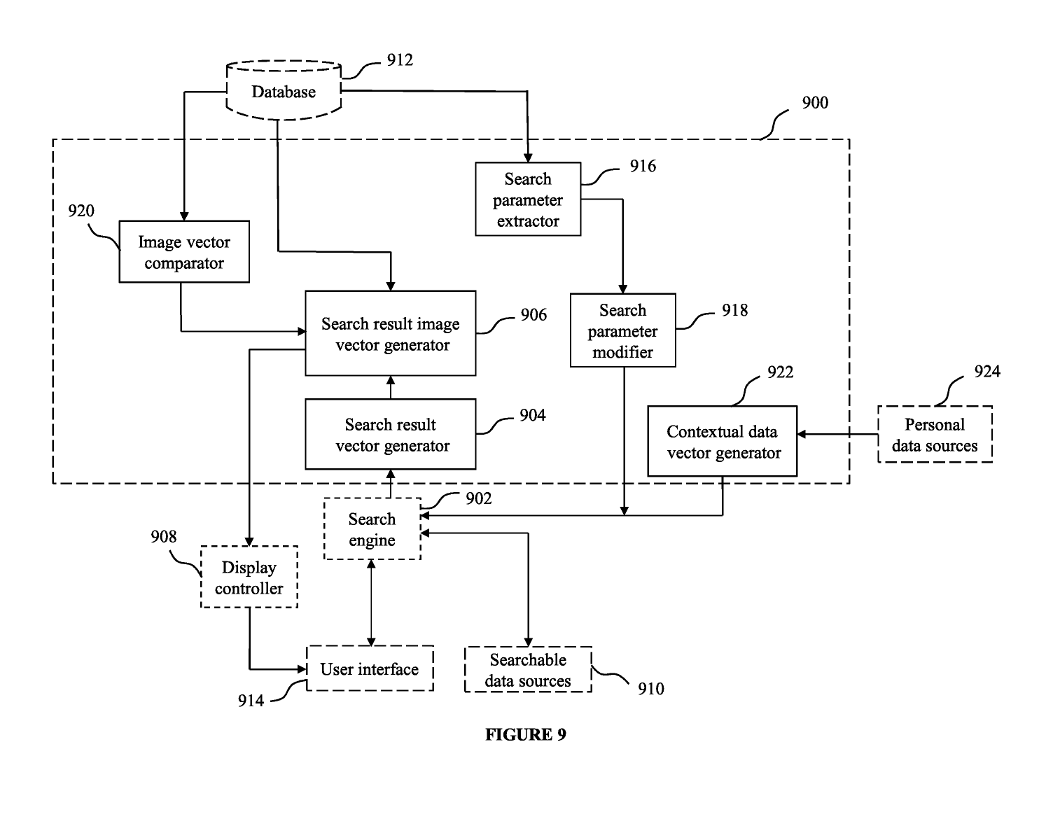

FIG. 9 illustrates a system embodiment of the invention. System 900 utilizes a search engine 902 configured to execute search queries through one or more searchable data sources 910. Search engine 902 may receive search terms for a search query through user interface 914. Search results returned by search engine 902 may be communicated to search result vector generator 904, which is configured to generate a search result vector corresponding to a search result returned by the search engine. The generated search result vector(s) may comprise a plurality of dimensions, at least one of which dimensions may comprise one or parameters or items of information including which (i) identify the corresponding search result, (ii) link to the corresponding search result or a part of the corresponding search result, (iii) describe or reproduce at least a part of the corresponding search result, or (iv) indicate relevance of the search result.

One or more generated search result vectors may be communicated to display controller 908, which can generate a search result image based on the search result vectors, for display on user interface 914. One or more generated search result vectors may alternatively be communicated to search result image vector generator 906, which is configured to generate a search result image vector. The search result image vector may comprise a plurality of vector dimensions, one or more of which may identify the search results for display and display attributes of each search result. In an embodiment of the invention, the vector dimension(s) corresponding to a description of search results to be displayed may include identifiers of or links to search result vectors corresponding to each search result that is to be displayed. The vector dimension(s) describing display attributes of each search result may include one or more of (i) descriptor or content corresponding to the search result that is intended to be displayed (ii) display location, (iii) size, (iv) shape, (v) color, and (vi) any other display attributes specific to rendering the search result on a display.

Search result image vectors generated by search result image vector generator 906 may be communicated to display controller 908 for display of a corresponding search result image on user interface 914. Generated search result image vectors may be stored in database 912.

System 900 may include search parameter extractor 916 configured to (i) retrieve from database 912, or to otherwise receive, a search result image vector and (ii) extract from said search result image vector, one or more search terms or search queries based on which the corresponding search result image vector was generated. The extracted search terms or search queries may be further communicated to search parameter modifier 918, which is configured to modify said search terms or search queries and may route the modified search terms or search queries to search engine 902 for execution of search.

System 900 may also include an image vector comparator 920 configured to retrieve from database 912, or to otherwise receive, first and second search result image vectors and to execute at least one data set operation based upon a first data set comprising the first image result image vector and a second data set comprising the second image result image vector. Results returned by the executed at least one data set operation may be communicated to search result image vector generator 906 for generation of a corresponding search result image vector.

System 900 may in an embodiment include contextual data vector generator 922 configured to obtain or receive context specific data relevant to a user, from personal data sources 924 relevant to or associated with such user. Context specific data received by contextual data vector generator may be communicated to search engine 902 for contextualizing a user's search terms or search queries. Alternatively, contextual data relevant to a user may be used to generate a contextual data vector, which may thereafter by used in accordance with any of the method embodiments discussed previously.

It would be understood that system 900 may be implemented using one or more processors or processing devices. Additionally, search engine 902, search result vector generator 904, search result image vector generator 906, display controller 908, user interface 914, search parameter extractor 916, search parameter modifier 918, image vector comparator 920, and contextual data vector generator 922 may be implemented using one or more individual processors. In an embodiment two or more of above system elements 902 to 924 may be implemented using a common set of processors. Database 912, searchable data sources 910, and personal data sources may each comprise of non-transitory computer readable memory.

Although not shown in FIG. 9, system 900 may additionally include one or more of:
(i) an authentication controller configured to control access to the system, and enable users to log in to individual data accounts. The access controlled system ensures that search result histories (including stored search result vectors and search result image vectors generated by user searches) may be confidentially maintained.
(ii) a summary controller, configured such that selection of one or more search results displayed within a search result image causes an extract or a summary of the data, information, documents, webpages or websites corresponding to such search result to be added to a summary document or file—which summary document or file may be stored and/or communicated. The summary controller may additionally be configured to add to said summary document or file, a link to (or location of) data, information, file, document, webpage or website corresponding to said search result.
(iii) A vector import/export controller configured to (a) transmit to third party devices or systems, search result vectors, search result image vectors and contextual data vectors generated within system 900, and (b) to receive from third party devices or systems, search result vectors, search result image vectors and contextual data vectors generated by such third party devices or systems.
(iv) A data push controller configured to enable a user to identify specific information, data, files, websites or webpages (for example, by way of a data push, or by identifying links thereto or locations thereof) (i) on which a search query extracted from a previously generated search result image vector is required to be run (ii) or which requires to be added to the searchable data sources of the system or (iii) based on which a summary vector and/or a corresponding summary image is required to be generated. The search results returned in response to the data push may be further used to modify the original search result image vector and/or search result image.

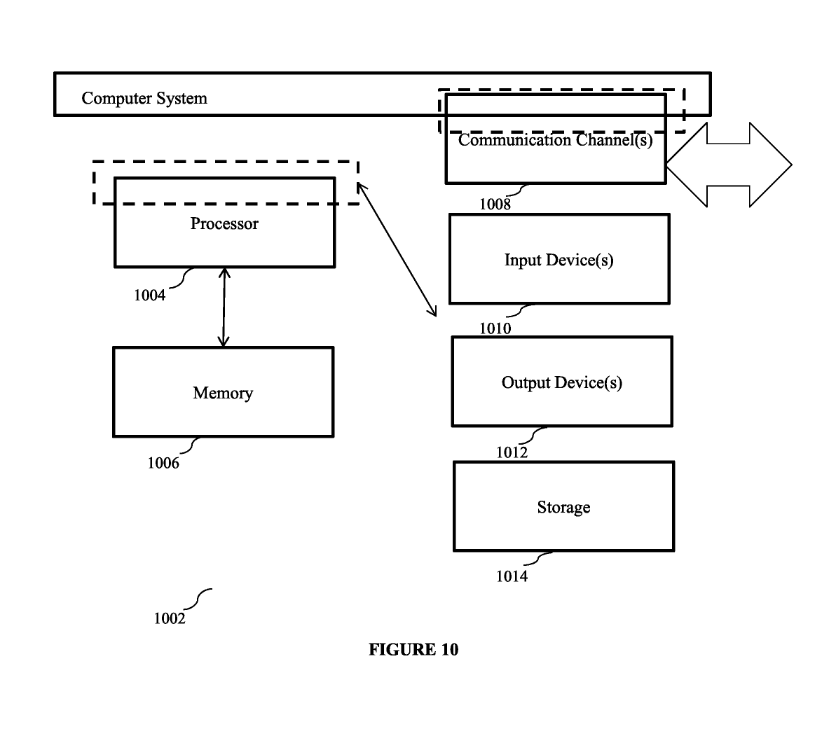

FIG. 10 illustrates an exemplary system in which various embodiments of the invention may be implemented.

The system 1002 comprises at least one processor 1004 and at least one memory 1006. The processor 1004 executes program instructions and may be a real processor. The processor 1004 may also be a virtual processor. The computer system 1002 is not intended to suggest any limitation as to scope of use or functionality of described embodiments. For example, the computer system 1002 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 1006 may store software for implementing various embodiments of the present invention. The computer system 1002 may have additional components. For example, the computer system 1002 includes one or more communication channels 1008, one or more input devices 1010, one or more output devices 1012, and storage 1014. An interconnection mechanism (not shown) such as a bus, controller, or network, interconnects the components of the computer system 1002. In various embodiments of the present invention, operating system software (not shown) provides an operating environment for various softwares executing in the computer system 1002, and manages different functionalities of the components of the computer system 1002.

The communication channel(s) 1008 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 1010 may include, but not limited to, a touch screen, a keyboard, mouse, pen, joystick, trackball, a voice device, a scanning device, or any another device that is capable of providing input to the computer system 1002. In an embodiment of the present invention, the input device(s) 1010 may be a sound card or similar device that accepts audio input in analog or digital form. The output device(s) 1012 may include, but not limited to, a user interface on CRT or LCD, printer, speaker, CD/DVD writer, or any other device that provides output from the computer system 1002.

The storage 1014 may include, but not limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1002. In various embodiments of the present invention, the storage 1014 contains program instructions for implementing the described embodiments.

While not illustrated in FIG. 10, the system of FIG. 10 may further include some or all of the components of the system of the type more fully described in connection with FIG. 9 above.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1002. The method described herein is typically implemented as a computer program product, comprising a set of program instructions which is executed by the computer system 1002 or any other similar device. The set of program instructions may be a series of computer readable codes stored on a tangible medium, such as a computer readable storage medium (storage 1004), for example, diskette, CD-ROM, ROM, flash drives or hard disk, or transmittable to the computer system 1002, via a modem or other interface device, over either a tangible medium, including but not limited to optical or analogue communications channel(s) 1008. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A processor implemented method for information retrieval comprising the steps of:
receiving a first plurality of search results returned by the search engine in response to a first search query;
generating a first plurality of search result vectors, wherein each of the first plurality of search result vectors is generated based on a corresponding search result from among the first plurality of search results and comprises data describing the corresponding search result;
generating a first search result image vector based on data from the first plurality of search result vectors; and
displaying information representative of the first plurality of search results on a display device, wherein visual configuration of the displayed information is based on data within the first search result image vector.

2. The processor implemented method for information retrieval as claimed in claim 1, wherein:
each of the first plurality of search result vectors comprises a plurality of dimensions; and
one or more of the plurality of dimensions records parameter data descriptive of the corresponding search result.

3. The processor implemented method for information retrieval as claimed in claim 2, wherein at least one of the first plurality of search result vectors comprises first, second and third dimensions, and wherein:
the first dimension records identifier data related to the corresponding search result;
the second dimension records location of data that caused the search engine to return the corresponding search result; and
the third dimension records:
a data summary of, or data extract from, the corresponding search result;
one or more of strings, topics, concepts, sentiments or frequency of occurrence of specific data, within the corresponding search result; or
a score indicating relevance of the corresponding search result.

4. The processor implemented method for information retrieval as claimed in claim 3, wherein the first search result image vector comprises a fourth, fifth and sixth dimensions, and wherein:
the fourth dimension records data corresponding to the first search query;
the fifth dimension records data identifying search results intended for display on the display device; and
the sixth dimension records:
data corresponding to a search algorithm used by the search engine;
one or more visual or textual identifiers used for display of a search result on the display device;
one or more display attributes of visual or textual identifiers;
relevance scores extracted from third dimensions corresponding to one or more of the first plurality of search result vectors;
information enabling access to one or more of the first plurality of search result vectors;
information describing data recorded within dimensions of one or more of the first plurality of search result vectors; or
predefined scoring criteria for comparing relevance scores of two or more of the first plurality of search result vectors.

5. The processor implemented method as claimed in claim 1, wherein the visual configuration of the displayed information is based on a comparison of relevance scores extracted from two or more of the first plurality of search result vectors.

6. The processor implemented method as claimed in claim 1, further comprising the steps of:
generating a second search query, wherein the second search query differs from the first search query in at least one search parameter or in at least one data source on which the second search query is intended to be executed; and
transmitting the second search query to the search engine.

7. The processor implemented method as claimed in claim 6, comprising the steps of:
receiving a second plurality of search results returned by the search engine in response to the second search query;
generating a second plurality of search result vectors, wherein each of the second plurality of search result vectors is generated based on a corresponding search result from among the second plurality of search results and comprises data describing the corresponding search result;
generating a second search result image vector based on data extracted from the second plurality of search result vectors; and
displaying information representative of the second plurality of search results on a display device, wherein visual configuration of the displayed information is based on data extracted from the second search result image vector.

8. The processor implemented method as claimed in claim 7, comprising implementing one or more data set operations based on a first data set comprising data from the first search result image vector and a second data set comprising data from the second search result image vector.

9. The processor implemented method as claimed in claim 8, comprising the steps of:
generating a third search result image vector based on a third data set resulting from the one or more data set operations; and
displaying the result of the one or more data set operations on a display device, wherein visual configuration of the displayed result is based on data extracted from the third search result image vector.

10. The processor implemented method as claimed in claim 8, wherein at least one of the implemented one or more data operations comprises a union operation, a difference operation or an intersection operation.

11. The processor implemented method as claimed in claim 6, wherein the second search query comprises one or more contextual search parameters based on contextual data associated with a querying user.

12. A system for information retrieval comprising:
a processor;
a search result vector generator configured to:
receive a first plurality of search results returned by the search engine in response to a first search query;
generate a first plurality of search result vectors, wherein each of the first plurality of search result vectors is generated based on a corresponding search result from among the first plurality of search results and comprises data describing the corresponding search result;
a search result image vector generator configured to generate a first search result image vector based on data from the first plurality of search result vectors; and
a display controller configured to display information representative of the first plurality of search results on a display device, wherein visual configuration of the displayed information is based on data within the first search result image vector.

13. The system as claimed in claim 12, wherein at least one of the first plurality of search result vectors comprises first, second and third dimensions, and wherein:
the first dimension records identifier data related to the corresponding search result;
the second dimension records location of data that caused the search engine to return the corresponding search result; and
the third dimension records:
a data summary of, or data extract from, the corresponding search result;
one or more of strings, topics, concepts, sentiments or frequency of occurrence of specific data, within the corresponding search result; or
a score indicating relevance of the corresponding search result.

14. The system as claimed in claim 13, wherein the first search result image vector comprises a fourth, fifth and sixth dimensions, and wherein:
the fourth dimension records data corresponding to the first search query;
the fifth dimension records data identifying search results intended for display on the display device; and
the sixth dimension records:
data corresponding to a search algorithm used by the search engine;
one or more visual or textual identifiers used for display of a search result on the display device;
one or more display attributes of visual or textual identifiers;
relevance scores extracted from third dimensions corresponding to one or more of the first plurality of search result vectors;
information enabling access to one or more of the first plurality of search result vectors;
information describing data recorded within dimensions of one or more of the first plurality of search result vectors; or
predefined scoring criteria for comparing relevance scores of two or more of the first plurality of search result vectors.

15. The system as claimed in claim 12, wherein:
the search result vector generator is configured to generate a second search query, wherein the second search query differs from the first search query in at least one search parameter or in at least one data source on which the second search query is intended to be executed; and
the processor is configured to transmit the second search query to the search engine.

16. The system as claimed in claim 15, wherein:
the search result vector generator is configured to respond to receipt of a second plurality of search results returned by the search engine in response to the second search query, by generating a second plurality of search result vectors, wherein each of the second plurality of search result vectors is generated based on a corresponding search result from among the second plurality of search results and comprises data describing the corresponding search result;
the search result image vector generator is configured to generate a second search result image vector based on data extracted from the second plurality of search result vectors; and
the display controller is configured to display information representative of the second plurality of search results on a display device, wherein visual configuration of the displayed information is based on data extracted from the second search result image vector.

17. The system as claimed in claim 16, further comprising an image vector comparator configured to implement one or more data set operations based on a first data set comprising data from the first search result image vector and a second data set comprising data from the second search result image vector.

18. The system as claimed in claim 17, wherein:
the search result image vector generator is configured to generate a third search result image vector based on a third data set resulting from the one or more data set operations; and
the display controller is configured to display the result of the one or more data set operations on a display device, wherein visual configuration of the displayed result is based on data extracted from the third search result image vector.

19. The system as claimed in claim 17, wherein at least one of the implemented one or more data operations comprises a union operation, a difference operation or an intersection operation.

20. A computer program product comprising a computer readable medium having computer readable instructions embodied therein for information retrieval, the computer readable instructions comprising instructions for:
receiving a first plurality of search results returned by the search engine in response to a first search query;
generating a first plurality of search result vectors, wherein each of the first plurality of search result vectors is generated based on a corresponding search result from among the first plurality of search results and comprises data describing the corresponding search result;
generating a first search result image vector based on data from the first plurality of search result vectors; and
displaying information representative of the first plurality of search results on a display device, wherein visual configuration of the displayed information is based on data within the first search result image vector.
